(19) United States
(12) Patent Application Publication
(10) Pub. No.: US 2008/0294550 A1
(43) Pub. Date: Nov. 27, 2008

(54) METHOD OF PRESERVING RAINFOREST

(76) Inventor: Paul D. Stoner, Powell, OH (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 11/858,110

(22) Filed: Sep. 19, 2007

Related U.S. Application Data
(63) Continuation-in-part of application No. 11/776,251, filed on Jul. 11, 2007, now abandoned.
(60) Provisional application No. 60/940,093, filed on May 25, 2007.
(60) Provisional application No. 60/957,762, filed on Aug. 24, 2007.

(51) Int. Cl. G06Q 99/00

(52) U.S. Cl. 705/39; 705/1

(57) ABSTRACT

A method of preserving land in which a large parcel of land is acquired. The land is divided into small sections referred to as tiles and these tiles are advertised for sale. Interested users purchase tiles via a website. Thereafter, the website delivers a printed deed and a preferably a satellite photo bearing indicia, such as the purchaser's name or photograph. The tile sales company can use profits from tile sales to buy more land and equipment.

### CROSS-REFERENCES TO RELATED APPLICATIONS

This application claims the benefit of U.S. Provisional Application No. 60/940,093, filed May 25, 2007, and U.S. Provisional Application No. 60/957,762, filed Aug. 24, 2007, and is a Continuation-In-Part of U.S. application Ser. No. 11/776,251 filed Jul. 11, 2007.

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

1. Field of the Invention

This invention relates generally to the use of technology, and particularly personal computers and the Internet, to preserve endangered rainforest by permitting the purchase of small plots thereof. More particularly, an investment process is provided for end users to purchase small parcels of endangered rainforest lands in affordable denominations and paying interest or increased value using one or more computer-based buying and selling processes.

2. Description of the Related Art

Rainforests of various kinds account for about twenty percent of the Earth's oxygen production. By way of example, the Amazon rainforests of Brazil are the most bio-diverse on the planet. These forests hold thousands of species of animal, insect, and plant life. These regions of the world are rapidly vanishing due to commercial de-forestation and development, which has a negative effect on oxygen production, carbon sequestration and wildlife.

Conventionally, environmentalists and other environmentally-concerned organizations can only take relatively insignificant measures to save endangered rainforests, in order to slow down their imminent extinction. These organizations take donations and buy rainforest land, but the size of the regions that can be purchased for preservation are quite small. This is a direct consequence of the relatively small amount of money that can be raised by environmentalists, conservationists, and concerned citizens in relation to the size of the need. These types of efforts and processes are appreciated and applauded by those who care about the environment, but are not effective enough to significantly reduce the problem of millions of acres of rainforest vanishing each year.

There are a few people who own or control sufficient wealth to afford the purchase of large quantities of rain forest land in order to halt or mitigate deforestation of these properties. And of those few, there are fewer still who could retain that land without obtaining some profit from the property's resources, most of which consist of the trees themselves. Nonetheless, there are many people of ordinary means who desire to solve the rainforest problem, but are unable to contribute substantial sums of money. For such people, the reward of helping is primarily emotional in nature, rather than financial. Additionally, although the amount of money each person could contribute would be small, the large number of such people multiplies the contribution immensely. Thus, there is little to no apparent financial incentive to the extremely wealthy who could afford to buy rainforest land and set it aside for preservation, and for the large number of people without the wealth necessary to purchase large tracts of such land, but for whom the environment is a substantial problem, there is no apparent means for purchasing the land.

Those trained in the art of fund raising will appreciate and understand that when the number of conservation participants is relatively small, and the financial rewards for participating are small or are not financially-related (e.g., only emotional), the results of the fundraising will also be small, on a relative scale. The disadvantage of such methods is that they are not able to raise enough money to significantly impact the pending rainforest extinction.

By contrast, “for-profit” institutions such as stock trading, municipal and government bonding programs, futures markets, and other similar investment vehicles attract millions of participants each day around the globe. Again, by example, a modern stock-exchange buys and sells millions of shares each day through public trading. On the same scale, modern cities and governments buy and sell millions of government bonds and municipal bonds each day around the world.

Furthermore, the popularity of personal computers and worldwide internet has allowed even the most modest income citizens to trade stocks. They perform buying and selling transactions quickly and easily from the privacy of their homes using only personal computers, an Internet connection and credit cards. These investors, which are sometimes referred to as “day traders”, are constantly seeking to balance profit-taking against risk. One way used by traders to balance risk is to diversify their investments across unrelated markets and companies.

There is a need, therefore, for a method by which the enormous number of people of modest means can contribute to the solution to the rainforest extinction problem.

### BRIEF SUMMARY OF THE INVENTION

Shares of rainforest land (herein referred to as “tiles”) are heretofore unknown, and they represent an excellent opportunity for sale of rainforest land to millions of investors over the world. The invention contemplates an apparatus used for preserving the environmental effect of a tract of land. The environmental effect includes the impact that land, including the living matter and minerals in and on the land, has on the air, water and other components of the environment. The land is owned by a first party and is divided into a plurality of tiles, which are preferably small parcels of land, such as one-eighth of an acre. The apparatus comprises means for displaying information to a group of persons, including a web site, unique identifiers associated with each of the tiles. In a preferred embodiment, each tile is given a unique identifier, and these identifiers are displayed on the web site to potential purchasers of the tiles. A computer facilitates a transaction in which the first party sells rights in at least one of the tiles to a second party. This can occur by conventional electronic commerce, or by other means of communication, such as the second party contacting the first party or the first party's surrogate by telephone. The invention also includes means for the second party to communicate to the first party desired indicia. The means for communicating can include the preferred web site, email, a telephone system or any equivalent means for communication. The desired indicia are any text and/or graphics that the second party communicates to the first party, such as the second party's name. The web site preferably displays the indicia in relation to the tile, such as by a graphical overlay on the web site.

In a preferred embodiment, a person or the computer prepares documents evidencing ownership of rights in said at least one tile, and such ownership documents can include a deed or equivalent instrument. It is also preferred for the computer to be configured to facilitate the sale of the second party's rights in said at least one tile to the first party, and calculate interest according to the amount of time the second party owned the rights in said at least one tile. The web site is preferably configured to facilitate a member of the public viewing the indicia, such as by displaying an aerial image of the tile with a graphical overlay of the indicia.

In a contemplated example, purchasers of tiles are motivated to buy tiles for conservation reasons. They derive the added benefit that the website allows them to designate the tile as a birthday or anniversary gift, or memorialize the tile in the name of a loved one, or deceased person, or simply attach their own name to the tile. In another contemplated example, a purchaser of tiles is motivated to buy because doing so helps with a fundraiser for a good cause, such as children's sports clubs or cancer research, due to attention drawn to the fundraiser from the indicia on the tiles, or by a profit that is realized by the purchase and then resale of the tiles. In another contemplated example, students or parents buy tiles to hold as a long-term investment vehicle to pay for a college education, start a business, or retirement. In yet another contemplated example, the website allows serious investors to buy and sell (i.e., trade) tiles on a more frequent basis, such as hourly, daily, weekly, monthly, etc, for the purpose of profit taking as with so-called “day traders”. By still another approach, the LTC website allows corporations to buy tiles in exchange for so-called “carbon credits”. By still another approach, the LTC website allows corporations to rent tiles owned by the LTC, or others, in exchange for so-called “carbon credits”.

### BRIEF DESCRIPTION OF THE SEVERAL VIEWS OF THE DRAWINGS

FIG. 1 is a flow chart diagram as configured in accordance with an embodiment of the invention.

FIG. 2 is a flow chart diagram as configured in accordance with an embodiment of the invention.

FIG. 3 is a schematic view of a web site configured in accordance with various embodiments of the invention.

FIG. 4 is a top view illustrating a photo-realistic land display of indicia and the tile as provided to a user in accordance with an embodiment of the invention.

FIG. 5 is a flow chart diagram illustrating the life of a tile in accordance with an embodiment of the invention.

FIG. 6 is a graph of tile pricing versus time in accordance with an embodiment of the invention.

In describing the preferred embodiment of the invention that is illustrated in the drawings, specific terminology will be resorted to for the sake of clarity. However, it is not intended that the invention be limited to the specific term so selected and it is to be understood that each specific term includes all technical equivalents that operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

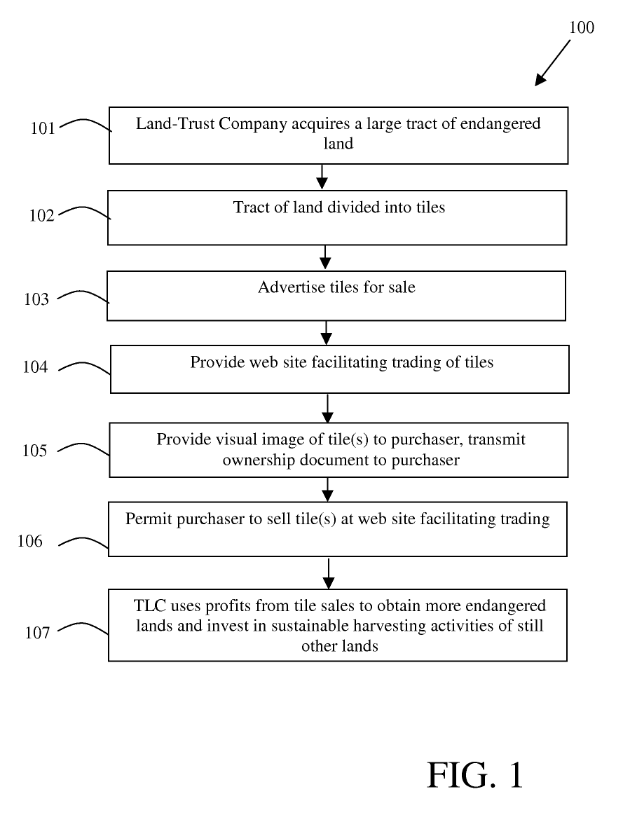

Pursuant to the various embodiments of the present invention, a preferred first step in the process of the invention includes the acquisition of a large parcel of land, for example, in the endangered Brazilian Amazon-region rainforest. The acquisition can be, for example, by a land-trust company (LTC), an individual or any entity. Referring to FIG. 1, the process 100 includes the step 101 of a LTC purchasing a large tract of land. The acquisition can be a purchase, lease, gift or any other transfer of rights, including partial rights such as mineral rights, from one entity to another. In an exemplary embodiment, the LTC purchases land ranging from a hundred or fewer acres to hundreds or even thousands of square miles.

Another step 102 is the division of that large tract of land into small parcels referred to as “tiles”. Each tile is preferably a fraction, such as one-eighth or one-quarter, of an acre. Of course, the size of the tiles can range from extremely small to relatively large, ranging from a size that makes the tile a novelty item, such as one square inch or one square meter, to a conventional size for a parcel, such as one acre or several acres. Each tile has restrictions, which can be deed restrictions, their equivalent, or other contracts, covenants or laws, that promote preservation and conservation, and prohibit or impose penalties for activity that fails to promote the ideals of the entity that originally purchases and divides the property. These restrictions can be contained within a deed or any other ownership documents for the rights in the tiles, or by contract.

The tiles are preferably advertised for sale in step 103 of FIG. 1. “Advertising” includes the posting of the existence of the tile for sale on a web site designed for buying and selling such tiles, as well as other conventional modes of advertising, such as print, television, radio and Internet. Each of the tiles preferably has associated with it a unique identifier, which can include the geographic location (e.g., latitude and longitude coordinates) of the tile. Such a unique identifier is preferably assigned by the computer on which the web site is established, and is associated with the unique geographic coordinates of the tile. The unique identifier aids in locating the tile on a map and with identifying the tile in the ownership documents. In addition, the tiles characteristics, such as its vegetation, slope, soil types, mineral deposits, etc. can be displayed.

Each tile displayed on the web site can be purchased by a second party, which is referred to herein as a purchaser, preferably using a worldwide website as noted in FIG. 1 at reference numeral 104 and preferably using conventional electronic commerce tools. Potential purchasers log into the website, or a site created by an intermediary entity, and purchase one or more rainforest tiles using conventional forms of currency, such as credit cards, prepaid accounts and the like. Tile purchasers search the web site, learn more information about tiles in which they are interested and, pay for tiles, including any associated transaction fees and taxes. It is preferred that the web site is resident on a computer or computers that are conventional for handling electronic commerce, and are connected to the internet in a conventional manner.

In one contemplated embodiment, the LTC or a related entity uses profits from tile sales to acquire more lands and fund equipment and labor costs for sustainable harvesting of other lands as in reference numeral 107. This is not required, but may be beneficial in some circumstances.

The computer, preferably through the web site in step 105 of FIG. 1, but alternatively through email or other means, transmits to the purchaser a deed or similar ownership document evidencing ownership of the purchaser of rights in the tile or tiles. It is not required for the ownership document to be an actual land deed as such. In fact, if it is illegal or economically unfeasible to create and register land deeds with the appropriate authorities for each tile, a contract between the purchaser and the seller can function as the ownership document. It is contemplated that an ownership document can be a certificate or other document that is useful only with the entity that owns and/or operates the web site at which the tile was purchased.

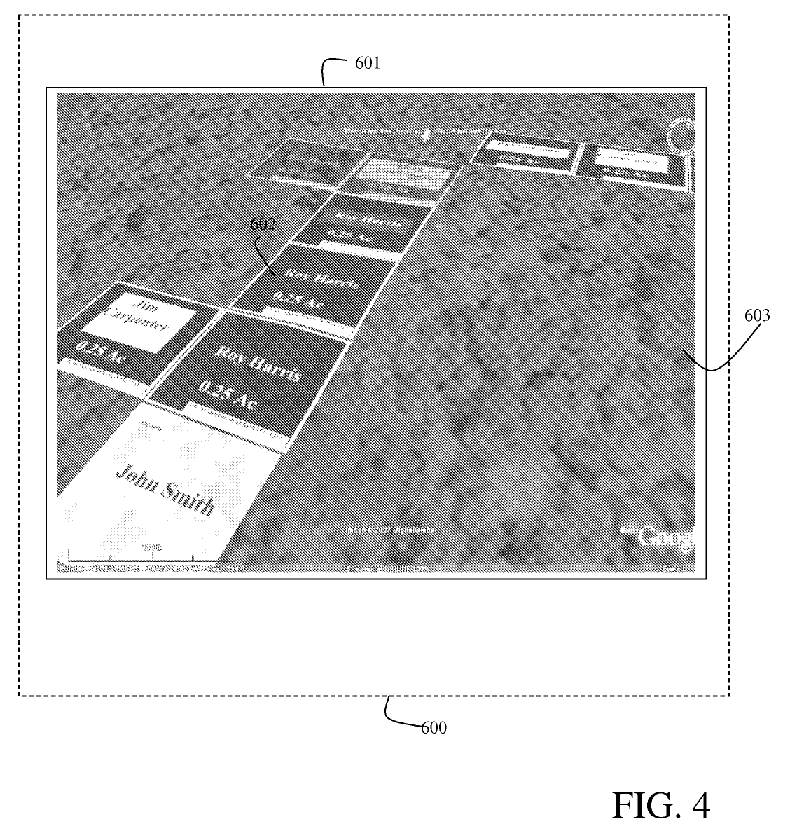

In addition to the ownership document, a visual image representing the tile or tiles purchased is available for viewing by the purchaser and preferably the public. The visual image can be an illustration, a satellite photo or any combination or equivalent that gives the purchaser a realistic view of the tile or tiles purchased. Such a visual image is displayed on the computer screen of the purchaser in a preferred embodiment, and provides real-time visual feedback and gratification to the tile buyer. It is preferred that the purchaser be given the opportunity to provide indicia, such as text, graphics, or the combination thereof, that is then simulated by the computer on which the web site is resident, to be displayed in the visual image placed over the tile(s), such as by the electronic construction of a simulated “road sign” posted in the tile or a translucent cover over the land (see FIG. 4). This can be accomplished using conventional computer graphic overlay as with Google Earth™ Maps and other known software. Preferably, the purchaser can instruct the seller through the web site to display any indicia acceptable to the seller that permits the purchaser to advertise, make a dedication or otherwise place any appropriate indicia on the tile(s). These indicia are preferably viewable by anyone in the public, such as by downloading the website.

The purchaser sees his or her name, photograph or any other desired indicia associated with the tile, such as by being overlaid on the rainforest tile immediately, or soon, after purchasing the tile(s). Thus, the tile(s) serves as a source of gratification, confirmation of his or her conservation efforts, and a memorialization on the Internet of the purchaser's name or other indicia. This can have a beneficial reaction-inducement to other onlookers who might become purchasers themselves.

In addition to the purchasing of tiles and placing of indicia on the tiles, purchasers also can sell or rent their tiles, and in the preferred embodiment thereby realize a profit from their investment. This takes place in the step of the purchaser offering to sell and selling tiles using the same website at which the tiles were purchased, or a related website, as noted in FIG. 1 at reference numeral 106. In one embodiment of the invention, tile owners can sell tiles to anyone. In a preferred embodiment, tile owners can only sell their tiles back to the party from which they were purchased, using the same website.

In some cases, a session on the website might result in several transactions, buying and/or selling tiles for any combination of motivations. By way of example, a father can log into the website to buy several tiles for his personal long-term investment portfolio, and in the same internet session, he can sell some tiles previously held for several years under his children's names to obtain cash to pay their college education expenses now due.

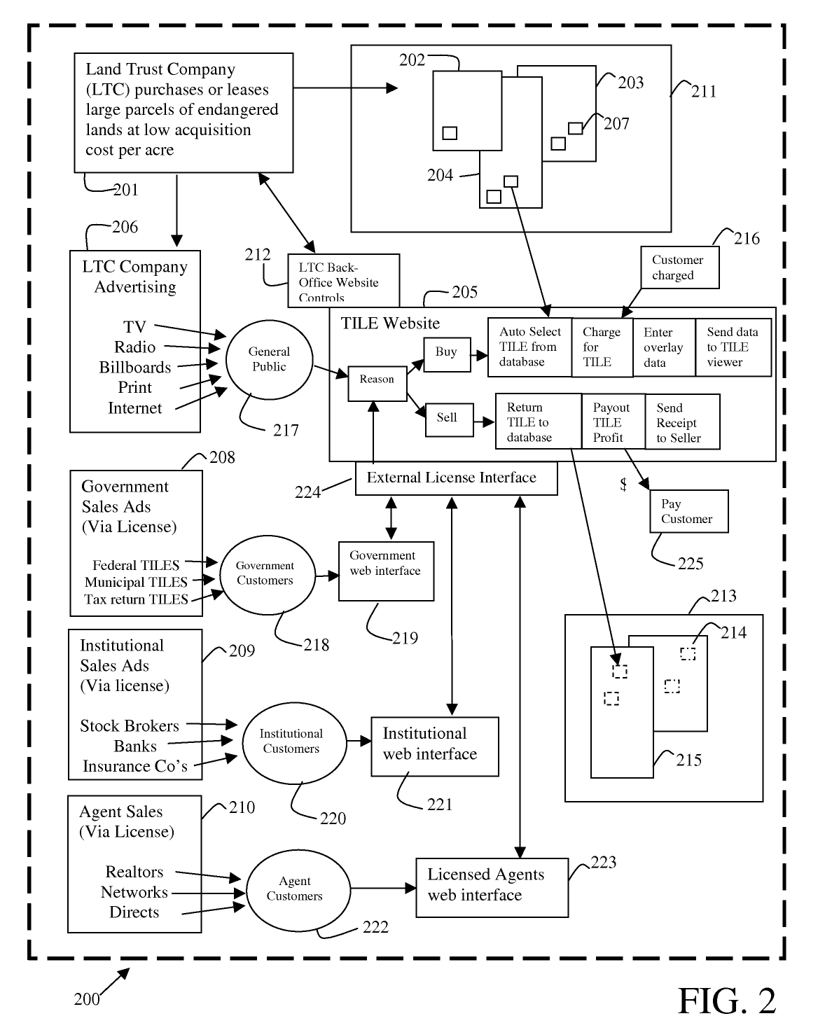

Referring to FIG. 2, those skilled in the art of internet commerce and website design will immediately understand the process flow 200 whereby the LTC 201 purchases large parcels 202, 203, and 204 of land and subdivides those parcels into tiles 207 which are tracked by a computer database system 211.

The tile web site 205 permits tile trading transactions with security, ease of use, and intuitive buttons and controls. The transactions occur easily and quickly, and give the users the ability to convert tiles back to cash by selling the tiles. So configured, the web site 205 also facilitates the buying and selling of rainforest tiles with automatic currency conversion between international money.

Such an approach can lead to dramatic reductions in the loss of rainforest lands per year. The invention allows large numbers of private citizens who are interested and capable of investing in stocks and bonds to invest in the rainforest. When a stock-trading approach is used to offer small pieces of rainforest land for sale on the internet or by any other means, the interest of many people interested in preserving the rainforest will see how this is similar in some ways to owning “shares” of a public company being bought and sold in public stock markets, having similar intrinsic investment value, and having potential for increasing value if held for some time period and then sold.

Referring again to FIG. 2, interested investors are attracted to the investment opportunity via traditional advertising 206, non-traditional advertising, government sales ads 208, institutional sales ads 209, agent sales ads 210 and word of mouth (not shown). Combining many functions into the single web site 205, with interfaces for other sales connections, results in further economy of scale since the total number of web sites and computers is small.

The tile trading process is described in further detail as follows. In an example, a person sees a television advertisement 206 aired by the LTC. The person, who can be from the population of any nation in the world 217, visits the LTC website 205 and clicks on the preferred reason for buying or selling tiles. One example could be for a birthday gift. It will be understood by the person having ordinary skill that the mechanism for trading tiles is not limited to a website. Any other acceptable means of facilitating the purchase and sale of any items can be substitute for the website. For example, a purchaser can telephone a toll-free telephone number, send an email or instant message, touch keys on a kiosk at a shopping mall, or any other suitable means.

Continuing with the web page example, the purchaser decides to buy or sell tiles. If she elects to buy tiles, the web site automatically selects an available tile from the database. It is possible for the customer to select a particular tile, but this is not preferred. The customer is then charged, at reference numeral 216, for the tile. After the customer's credit card has cleared, or the other form of currency is confirmed to be available, the customer is asked to enter her indicia to be used to construct the graphical overlay image that identifies the tile as belonging to this owner, among other things. Lastly, the LTC website sends a tile deed, and tile location and overlay data to the customer's personal computer in real-time, such as by email, in a cookie or simply by html language in her web browser. The customer's computer executes an image viewing program that shows the customer an aerial view of the property she has just purchased.

At some later time, the customer can visit the website 205 again and choose to sell her tile(s), preferably at a profit. This step involves returning the tile to the recycle database 213 and the website pays the tile owner for the tile. The amount paid to the tile owner can be the original purchase price plus a profit 225, or it can be with interest computed at a predetermined or variable rate. A premium or interest can be paid to the purchaser who sells his or her tile back to the website, and this can be an agreed upon amount or something that is determined based upon the market value of the tile.

Once the tile owner is paid, the tile is free to be sold to another customer as described above. A transaction receipt is then sent to the tile owner's computer via the Internet, such as by email. Of course, the receipt, and any other documents referenced above, can be sent via any communication means, including without limitation facsimile, regular mail, parcel service, or any other means.

In a preferred embodiment of the invention, the tile owner is restricted to selling his or her tiles to the previous title holder using the website 205 through which he or she purchased the tile. The amount of the sale price back to the website can then be locked in at the time of the initial purchase, so that the tile can appear to be more of an investment vehicle, for example, that earns an annual interest rate, such as 11%. If the customer retains the tile(s), he will receive that amount of increase in value over the purchase price for each year the tile is held when he sells the tile back to the original title owner. In such an embodiment, the tile cannot be sold to others apart from the website 205.

With reference to FIG. 2, the invention described above can lead to a dramatic reduction in the destruction of endangered lands such as rainforests. This is because consumers are motivated to participate to receive financial gain as well as the resulting emotional satisfaction of aiding in such a cause.

In addition to these features, the website 205 features an external license interface 224 which allows other licensed institutions 209, governments 208 and agents 210 to profit from their own brand-label promotion of the LTC website via indirect customers 218, 220, and 222 having access to the website via specialized licensed web interfaces 219, 221, and 223. The LTC tile database contains, for example, millions of tiles 207 sourced from a plurality of large land parcels 202, 203, 204, 214, and 215 all tracked in computer databases 211 and 213. Thus, by making all of these tiles available on a website, more tiles from more tracts can be sold, thereby increasing preservation of land.

If desired, these teachings will accommodate providing more than one such independent land source, which is represented in the illustration of FIG. 2 by an Nth tiles source parcel 202, 203, and 204 where “N” represents any integer value greater than one. For example, two or more such sources of tiles can supply tiles to one or more of the same databases 206. So configured, the websites have the benefit of redundant land sources and/or there is a larger number of tiles available from regions all over the world in the form of additional parcels of land owned by the LTC or other entities.

It is also possible to use such additional tile sources to provide additional non-tile allocated LTC land independent of tile lands. To illustrate, a first tile source could serve to source tiles to a first group of five LTC components, and a second land source could serve to source some tiles and some non-tile lands to be used for farming, harvesting, or other operations. There is no limitation to the use these other non-tile lands can be put. For example, the non-tile land can be harvested by the LTC company, or given, sold or leased back to governments or other companies to generate income for the LTC, or until such time as the LTC is able to add that tract of land into the tile database.

These and other benefits may become clearer upon a thorough review and study of the detailed description herein. Referring again to the drawings and in particular to FIG. 1, the process 100 is applicable in a wide variety of settings, including financial investment and preservation applications. For example, this process 100 has been presented in conjunction within the setting of an international website. Those skilled in the art will understand that this example is intended only as an illustrative case and is not to be taken as a suggestion that these teachings are limited in this regard. For example, the tiles can be advertised and sold in any applicable communication medium including, but not limited to, television, radio, print, distributed media (compact disks) or internet auction site.

The process 100 provides for provision of a source endangered lands. As will be understood, these tiles need not be endangered, as the preservation of any land containing plant life will accomplish a similar purpose. At present, there are investments paid for the purpose of restoring land or resources that are consumed or damaged in the course of doing business. Such investments are considered by governing authorities as “offsets” or “credits” against the consumption or damage. Such credits or offsets enable entities to make up for the negative impact they have on the environment. These credits are sometimes referred to in the industry as “Carbon Credits” due to the fact that the plant and animal life destroyed or displaced by the activity was carbon-based and therefore has a negative impact on the environment. Rainforests are particularly appropriate for carbon credits, because existing forests have measurable and present ecological value. By way of example, one scientific study has found that, on average, 2.47 acres of rainforest will absorb 1 metric tonne (2205 lbs) of CO₂ greenhouse gas per year, and convert it back to breathable oxygen. This is defined as 1 Carbon Credit in the green industry.

Those skilled in the art will also recognize that these teachings will be equally applicable to land having other desirable qualities, including without limitation clean rivers and lakes that may contain endangered species. As continued profits make possible the purchase and offering of other types of land, those land types are introduced having similar investment grade qualities.

The invention described herein can be enhanced by displaying, in the website 205, up-to-the-minute tile data, pricing, rate of return, and physical description of tiles, such as size and location. Additionally, hyperlinks can be presented for tile buying and selling portals for different types of tiles, such as those that are personally owned, gift, fund raising, college savings, investor, banks, brokers, and carbon credit tiles. One can also provide links to tile buying portals accepting credit card payments, periodic installment payments, where processing fees and taxes are included, where the buyer deposits funds into seller's bank account or credit card account, and those with a data connection to tile viewing software. Furthermore, links to portals that sell tile to buyers or back to the land-trust company return sold tiles to a LTC database and make them available for re-sale. Still further, one can provide infomercials and text descriptions of tile programs and profit trend data, as well as data showing how much endangered land has been saved.

It is also contemplated, in the website 205, to provide lifestyle questions in order to calculate the number of tiles needed to offset a person's carbon footprint, the ability to enter a number of tiles desired and calculate the profit potential over time. Additionally, it is contemplated to have a mechanism for giving tiles as gifts, in which a recipient's name and address and other information can be entered, and then after the purchase of the tiles the ability to send the ownership document, visual image and other items, such as gift cards, to the recipient. Still further, an investor portion of the website can permit investors to enter the number of tiles to buy per period of time, such as each week or month, the number of years before selling back the tiles and then perform a calculation of the total value of the investment at the time of the sale back. Likewise, a carbon credit page permits one to enter the number of tiles to buy and then calculate the number of carbon credits received. Other information can be entered, such as the company information.

The preferred website can be constructed taking into consideration conventional factors. Those skilled in the art will appreciate that the above-described processes are readily put in place using any of a wide variety of available and/or readily configured platforms, including partially or wholly programmable platforms, as are known in the art, or dedicated purpose platforms as may be desired for some applications.

For the purpose of illustration, an apparatus for use with the present invention includes a personal computer or server. The source of tiles comprises, in the preferred embodiment, a rainforest component. This source of tiles operably couples via an international website to a tile sales portal and a tile redemption/resale portal where tiles are redeemed for cash or other monetary instrument.

If desired, one can also optionally couple more than one international web site to a given single parcel source of tiles as suggested by the international web site. Such additional international websites can couple in a similar manner to other single parcel tiles land sources. So configured, those skilled in the art will recognize the resultant tile distribution/sales website architecture as comprising a “star” distribution pattern. With such a configuration, connecting a plurality of the international web sites will not have any effect upon the operability of the remaining international web sites. It would also be possible for separate whole sets of tiles databases, and consequently tile sources, to be cross-coupled across a plurality of website server computers for fail-functional operation.

It is not necessary, although it is possible, that the source of tiles, either alone or in the aggregate with other sources of tiles, be capable of providing an instantaneous amount of tile sales demand, in real time. By way of example, the LTC might run a national TV ad promoting the sales of tiles. All of the electrically powered LTC components may be coupled thereto. A properly sized rechargeable power supply should ensure that sufficient energy is available to operate such components for the duration of a given desired or planned operating period, such as a given tile of the LTC.

Also as noted above, the source of tiles can be provided with an identifier (that may be stored, for example, in a corresponding memory) that is unique, or substantially unique, to the LTC itself. This identifier can be provided, for example, to a computer database of tiles containing all information pertaining to each tile (such as, but not limited to, the owners name, address, the location of the tile (latitude and longitude) the price of the tile, the date the tile was purchased, Carbon Credit data associated with the tile, and the type of tile) with the identifier information. Various numerical coding schemes are known in the art and may be applied here as appropriate. The amount of data stored per tile can comprise, if desired, a relatively low number of data bytes to reduce storage requirements of millions of tiles worldwide. It will also be understood that such information can be transmitted between computers on a substantially continuous, repeated basis or can be transmitted less frequently as desired.

Those skilled in the art will recognize and understand that such an apparatus may be comprised of a plurality of physically distinct elements. It is also possible, however, to view this illustration as comprising a logical view, in which case one or more of these elements can be enabled and realized via a shared platform. It will also be understood that such a shared platform may comprise a wholly or at least partially programmable platform as are known in the art.

These teachings provide a highly leveragable basis for preserving endangered lands throughout an application setting of choice. These teachings are readily implemented in an economically feasible manner and can easily scale to accommodate a wide range of needs and requirements. It will further be appreciated that these teachings can lead to significant reductions in the global warming component due to deforestation. These teachings also serve to permit additional forest-preserving uses of tiles, by way of example, as source of edibles, such as fruits and nuts, minerals, such as gold, or gemstones shaft-mined from underground, in the earth directly below tiles without disturbing the forest on the surface of the tile, or through the sale of oil and gas rights to other parties.

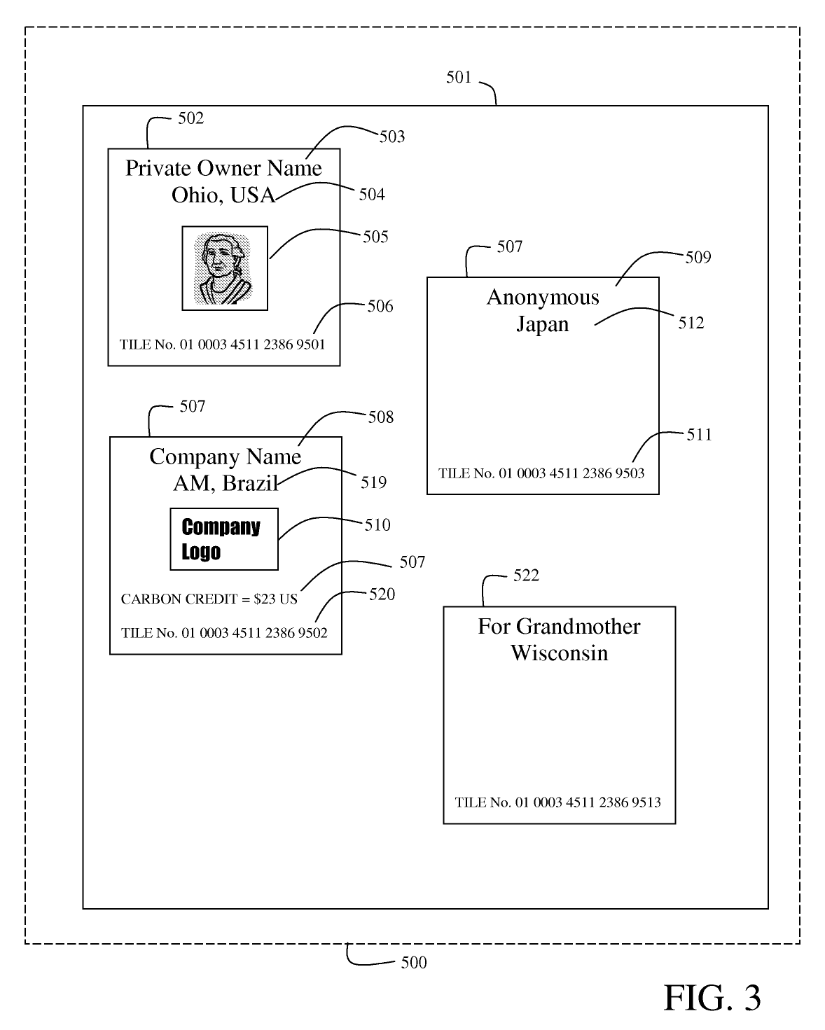

Referring to FIG. 3, an illustrative approach to tile graphic overlay labeling is discussed. Any of a variety of labels 500 can be considered for application in this regard. For example, the trader's name 503, and home country 504, 512 and 519 might be included in the overlay graphic 502 as such information is a matter of pride in most countries. As another example, a tile may be labeled with the name 522 of a deceased family member, loved one, friend, or famous person, serving in this regard as a memorial to all who choose to download the general tile registry data 501 to their personal computer terrain viewer. As still another example, the overlay graphic could contain text 507 showing the number of “carbon credits” earned by company 508 as displayed by that company's graphic overlay 507. Each tile overlay is clearly marked with the unique world-wide identifier tile numbers 506, 511, and 520. Tile owners can optionally chose to add a photo of themselves a loved one, or a pet 505. Alternatively, if a company owns the tile, the visible indicia can include a graphic of that company's logo 510 or brand mark of a tile obtained, or currently holds through the purchase and ownership of the tile. For privacy reasons, some tile owners may choose to list their tile 507 names as Anonymous 509.

FIG. 4 shows an exemplary terrain view, as a customer would see on the display of his personal computer immediately after the purchase of a rainforest tile according to one embodiment of the invention. If desired, the brightness component of the overlay information can be varied by the viewer (and/or switched on and off completely) in order to provide the customer-viewer with an uncluttered view of their own personal or company owned rainforest tile(s). The purchaser can also modify other characteristics, if the computer is so programmed. Modern terrain viewing software currently accommodates these features, requiring only that the overlay graphic and latitude longitude data be downloaded from the rainforest web site to the terrain viewing software already loaded and running on the customer's personal computer.

Those trained in the art of modern internet advertising techniques will immediately recognize the advertising value of tile overlay graphics. With millions of people now using internet sites such at search engines, and driving-directions websites, a huge advertising business has sprung up which uses paid spots on these web sites to post tiny advertisements for products and services, designed to be viewed by people who clicked on the website for another reason. Rainforest tile overlays can be used in the same way as clickable advertisements, paid for by the companies who have purchased tiles. Application settings can be adjusted to increase the attention getting ability of the graphic overlay human-perceptible signal of sorts. It would also be possible to provide a means for company customers to download a visual data file containing the company's logo or other graphics and text that would serve as a positive form of advertising to onlookers in general who gaze at the terrain viewer. Since most users who purchase a tiles will want to click and view their piece of rainforest at least one time, these clicks create a totally new advertising medium for larger companies to have the public gazing at other nearby tiles that are labeled with that company's name and logo.

Those skilled in the art of modern computer graphics and terrain viewing systems will understand that the most intuitive approach for layman to view parcels of land is by using high-resolution satellite imagery 603 rendered by a computer program and displayed in a personal computer window 601. By one approach, a viewpoint 600 is automatically established based on the geo-coordinates of the tile just purchased by a new tile owner. A graphical overlay 602 is automatically computer-generated for each tile sold. The overlay contains information that was provided by the new owner of the tile during the checkout shopping-cart process. In the overlay approach, the tile graphical overlay image is layered on top of the earth terrain image. By way of example, the tile overlay graphic is made to appear translucent, so that the undisturbed rainforest (or other endangered feature of the land) can be readily seen by the owner.

The above-described graphical overlay is transmitted to the tile buyer's own personal computer during their session on the LTC's tile buying website. In fact, if desired, such a capability can comprise real-time exchange of data. In this way, the tile buyer can instantly see the tile they have purchased as soon as their credit card payment clears the checkout process.

Those skilled in the art of modern computer graphics viewing software systems will understand that the complete stand-along earth-terrain-viewing software (by way of example, Google Earth™ or MSN Earth™) and other such programs exist which can be launched by command over the internet to run in another window on the tile buyer's computer.

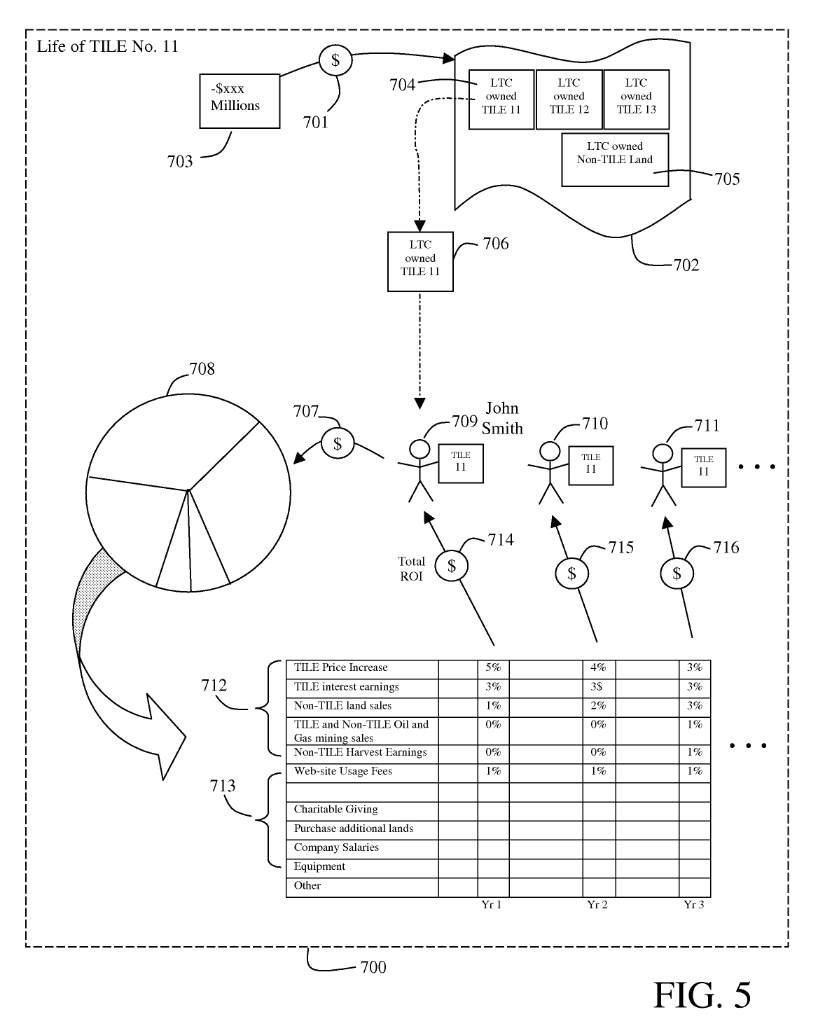

FIG. 5 depicts the process flow 700 “Life of tile No. 11” and shows the process steps involved over the life of a typical tile. Land purchase transaction 701 is shown whereby the LT Company invests millions of dollars 703 to purchase initial endangered lands 702 which are subsequently parceled into tiles lands 704 and non-tile lands 705. Non-tiled lands are set aside for other purposes as discussed elsewhere. Tile 11 706 is auto selected by the LT Company website during person John Smith's 709 tile buying experience, whereby John's credit card is charged for the retail price of the tile(s) including any associated taxes and fees depicted by financial transaction 707. The incoming gross sales proceeds for tile 11 706 are disbursed via PIE chart 708 into their respective sections of profit generating activities 712 and company indirect activities 713. At the time of tile 11 706 maturity date, the LT Company pays John 709 a Return On Investment (ROI) 714. This total ROI 714 is comprised of the sum of several interest bearing components 712. It is important to note that the total payback 714 to John 709 for his tile 11 706 comes from several sources, and not only from the price increase of the tile over time. In this manner, the price increase of the tile 11 706 over time can be kept low, as to not over-inflate the price of the tile too quickly. This is further explained in the following paragraphs and in FIG. 8. Because the price of the tile 11 706 is carefully controlled in one embodiment, the tile can have a long life and be traded (bought and sold) many times. Person 710 buys the tile from the LTC website after John 709 sells his tile for a profit. LTC payout 715 occurs when Person 710 sells tile 11 after its second maturity date. Person or company 711 purchases tile 11 706 from person 710 for the third time and sells it back in transaction 716 for a profit. As time goes on, the ratios of the profit components listed in table 712 may change. For example, in the early years of LTC operation, tile price increase, and tile interest earnings may be the greatest source of profit for the tile seller. In later years, tile price increases are rolled back and augmented by new profits coming in from harvesting operations, website fee profits, and non-tile land sales profits 712.

Those skilled in the art of commodity trading will recognize that the future prices of tiles cannot exceed the market value of the tile. The “per tile” acquisition price can be quite low, if the LTC buys large sections of endangered lands and sub-parcels them into tiles. The retail “per tile” market price can be significantly higher, since single tiles are small size properties, sold per previous teachings. Even so, the “per tile” price of a tile cannot exceed the fair market value of a similar sized property on the open market. As a tile matures, and is sold from one owner to the next, each new owner pays more for the tile than the previous owner did. However, a tile price increase over time can only account for some of the profit paid to the previous tile owner.

Historically speaking, the appreciation of land always tracks roughly with inflation, at least over long periods of time. In most countries long-term inflation ranges from 1% to 5% per year, typically averaging 2-3%. To attract large numbers of customers to invest in tiles the LTC must offer a significantly higher rate of return (by way of example 8-12% APR). Such a high, guaranteed, fixed rate of return draws customers away from lower performing fixed rate investments such as bonds, CDs, Savings accounts, 401(K) plans, etc. However, if tile price alone were allowed to continually increase at this rate it would cause the price of tiles to rise too fast from year to year. By way of example,

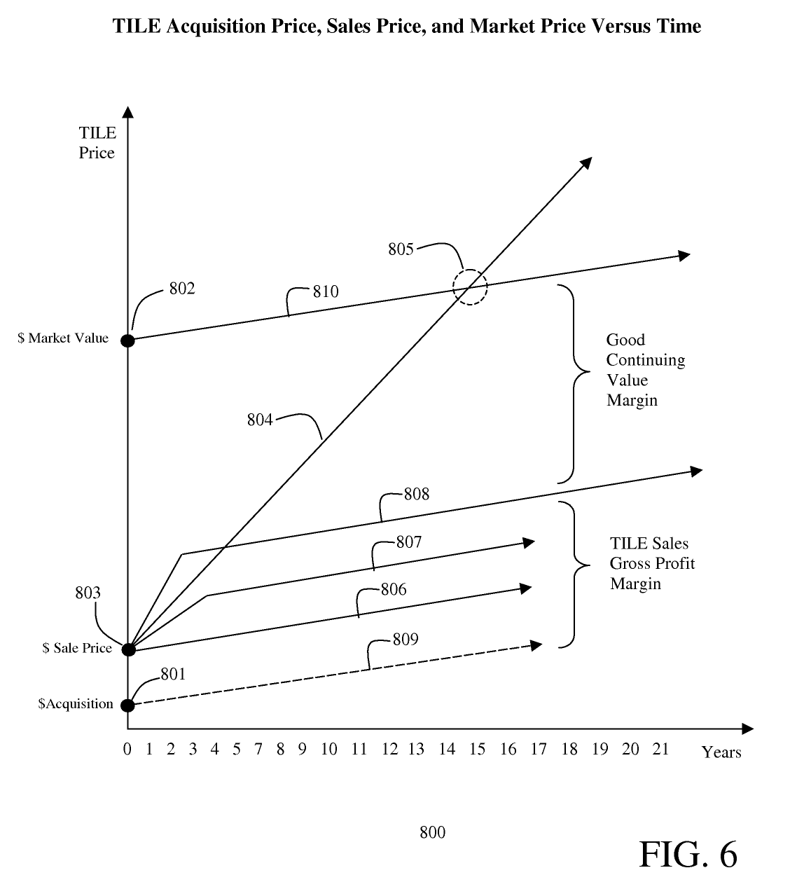

FIG. 6 shows a graph 800 that plots Tile Acquisition Price, Sales Price, and Market price versus Time. To begin with, tiles are purchased by the LTC in large quantities for an acquisition price 801. That price is significantly lower than the fair market value 802 of a parcel of land of similar size as a tile. By way of example, one million acres of rainforest in Brazil can be purchased in 2007 pricing of $8-$40 per acre or $1-$5 per tile 801. The fair Market Value 802 of that same land, in one acre quantity in Brazil might easily exceed $1000-$5000 per acre for land with good title and location. This is an important aspect of the invention, since the retail sales price of a tile can be located comfortably between the wide spread of 801 and 802. The price difference between 801 Acquisition Price and 803 Sales Price forms the starting basis for paying tile customers a high-rate-of-return. However, if the price of tiles 803 starts at US$79 per tile and is allowed to grow at 12% APR as shown (a rate that will attract many tile customers) then the price of a tile 803 will grow along a trend line 804 until it exceeds the fair market value 810 of the actual land at intersection point 805 and the LTC will fail because eventually customers will stop investing in overvalued tiles, that they themselves could buy on the open market at a lower price.

Continuing to refer to FIG. 6, a particularly important aspect of the invention is tile pricing methodology whereby tile prices are allowed to rise quickly in the first few years of LTC operations. By one example, tile sales price 803 is allowed to increase over time, following trend line 806, which avoids future over pricing of the tile, since trend line 806 grows at the same rate as inflation (e.g. 2-3% APR). Historically, the fair Market Value of a tile 802 and 810 also grows at this same general rate of inflation. Because of this, trend line 806 should never approach trend line 810. The final result being that a tile will always retain good value for the tile owner. In other words, a tile will never be overpriced in the market. However, trend line 806 also has the acute drawback of providing a very low interest rate of return to the tile investor. Trend lines 807 and 808 show a better way to price tiles, revealing a key aspect of how the invention overcomes the low-interest problem. In trend line 807 the price of the tile is allowed to rise quickly over the first few years of operation of the LTC. This has two very important effects. First, it causes much more income to be generated from gross tile sales. This income is needed to fund the start-up of sustainable harvesting operations, and pay continuing interest on all tiles ever sold. The second important effect of pricing trend 807 is that the general public sees in the LTC advertisements showing a rapidly rising rate of return for tiles and they become more excited and motivated to join in the program. Trend line 808 shows this pricing strategy again but more pronounced, whereby initial sales price 803 is allowed to rise even more steeply in the early months, or years of LTC growth. The rapid rise in tile price trend 808 must however be checked at some point, or the price of a single tile would rapidly exceed the fair Market Value of a tile 802, 810. After the first few years, the tile price trend 808 is raised at a slower rate, by example, the same as the rate of inflation. In this manner, the Current tile price always stays below the Market Value of the tile by a price spread referred to as the Good Continuing Value Margin. The overall goal in tile pricing is to keep the tile price well above the acquisition price of the land 801, and 809, while at the same time taking care not to let the price of a tile rise too close to, or above, the fair Market Value of a tile 802, 810.

Those skilled in the art will recognize and understand that such a method may be deployed as a plurality of sales and service computer portals, physically distinct, and installed at diverse locations world-wide. So configured, those skilled in the art will recognize and appreciate that these teachings provide a highly leveragable basis for providing general preservation and conservation throughout an application setting of choice. These teachings are readily implemented in an economically feasible manner and can easily scale to accommodate a wide range of needs and requirements. It will further be appreciated that these teachings can lead to significant profits for both the LTC and tile customers. These teachings also serve to permit a moral and sustainable use of tiles as both a conservation medium, and as a profit medium. Those skilled in the art will also recognize the value of providing a unique identifier in conjunction with the delivery of tiles throughout an application setting. Those skilled in the art will also recognize the cost savings associated with buying the largest possible size parcels of endangered lands.

In the preferred embodiment of the invention, the LTC pays interest in currency. In an alternative embodiment, rather than the LTC paying interest in currency, LTC pays interest in the form of valuable assets, such as additional tiles. In this alternative, the tile price is maintained the same (or adjusted for inflation), and tile owners are awarded additional tiles over time, so that when they sell their tiles, they sell more tiles than the owners originally purchased. The money received from the sale of the additional tiles becomes, in effect, the “interest” paid to the tile owner, but that interest is not realized until the sale of the original tiles. Alternatively, the additional tiles are added to the tile owner's account before sale of the originally purchased tiles. In this method, the LTC thereby “pays interest” prior to the sale of the original tiles, in the form of increasing the number of tiles the tile owner holds, rather than increasing the value of the same number of tiles.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A method of preserving the environmental effect of real property, the method comprising:
(a) a first party purchasing a tract of land;
(b) dividing the tract of land into a plurality of tiles;
(c) the first party selling rights in at least one of the tiles to a second party;
(d) the second party instructing the first party as to a desired indicia; and
(e) displaying the indicia in relation to said at least one tile.

2. The method in accordance with claim 1, further comprising the step of the first party conveying to the second party documents evidencing ownership of rights in said at least one tile.

3. The method in accordance with claim 1, further comprising the step of the second party selling the rights in said at least one tile to a third party.

4. The method in accordance with claim 1, further comprising the step of the second party renting the rights in said at least one tile to a third party.

5. The method in accordance with claim 1, further comprising the step of the second party selling the rights in said at least one tile to the first party.

6. The method in accordance with claim 5, further comprising the first party paying to the second party a premium for the rights in said at least one tile.

7. The method in accordance with claim 5, further comprising the first party paying to the second party interest according to the amount of time the second party owned the rights in said at least one tile.

8. The method in accordance with claim 7, further comprising the second party viewing the indicia.

9. The method in accordance with claim 7, further comprising a member of the public viewing the indicia.

10. The method in accordance with claim 7, further comprising harvesting resources from said at least one tile.

11. The method in accordance with claim 7, further comprising the first party restricting the second party in how the second party exercises its rights in said at least one tile.

12. The method in accordance with claim 1, further comprising associating with each of said plurality of tiles a unique identifier.

13. An apparatus used for preserving the environmental effect of a tract of land owned by a first party and divided into a plurality of tiles, the apparatus comprising:
(a) a web site that displays to a group of persons unique identifiers associated with each of said tiles;
(b) a computer that facilitates a transaction in which the first party sells rights in at least one of the tiles to a second party;
(c) means for the second party to communicate to the first party a desired indicia; and
wherein the web site displays the indicia in relation to said at least one tile.

14. The apparatus in accordance with claim 13, further comprising documents evidencing ownership of rights in said at least one tile.

15. The apparatus in accordance with claim 13, wherein the computer is configured to facilitate the sale of the second party's rights in said at least one tile to the first party.

16. The apparatus in accordance with claim 15, wherein the computer is configured to calculate interest according to the amount of time the second party owned the rights in said at least one tile.

17. The apparatus in accordance with claim 16, wherein the web site is configured to facilitate a member of the public viewing the indicia.

18. An apparatus used for preserving the environmental effect of a tract of land owned by a first party and divided into a plurality of tiles, the apparatus comprising:
(a) means for displaying to a group of persons unique identifiers associated with each of said tiles;
(b) means for effecting a transaction in which the first party sells rights in at least one of the tiles to a second party;
(c) means for the second party to communicate to the first party a desired indicia; and
(d) means for displaying the indicia in relation to said at least one tile.

19. The apparatus in accordance with claim 18, further comprising documents evidencing ownership of rights in said at least one tile.

20. The apparatus in accordance with claim 18, further comprising means for selling the rights in said at least one tile to the first party.

21. The apparatus in accordance with claim 18, further comprising means for renting the rights in said at least one tile to the first party.

22. The apparatus in accordance with claim 21, further comprising means for calculating interest according to the amount of time the second party owned the rights in said at least one tile.

23. The apparatus in accordance with claim 22, further comprising means for a member of the public viewing the indicia.
